(19) United States
(12) Patent Application Publication
(10) Pub. No.: US 2026/0278822 A1
(43) Pub. Date: Sep. 17, 2026

(54) SYSTEM FOR VISCOSITY DETERMINATION VIA THIN-FILM IMAGE PROCESSING

(71) Applicant: INDIAN INSTITUTE OF TECHNOLOGY BOMBAY, Mumbai (IN)

(72) Inventors: Mahesh S. TIRUMKUDULU, Mumbai (IN); Mahrukh Arif MIR, Mumbai (IN)

(73) Assignee: INDIAN INSTITUTE OF TECHNOLOGY BOMBAY, Mumbai (IN)

(21) Appl. No.: 19/564,684

(22) Filed: Mar. 12, 2026

(30) Foreign Application Priority Data
Mar. 12, 2025 (IN) 202521022216

(51) Int. Cl. G06T 7/60; G06T 7/13; G06T 7/90; H04N 23/74

(52) U.S. Cl. CPC G06T 7/60; G06T 7/13; G06T 7/90; G06T 2200/24; G06T 2207/10024; G06T 2207/20101; G06T 2207/30004; H04N 23/74

(57) ABSTRACT

The present invention provides an automated viscosity measurement device that utilizes image analysis to determine the viscosity of liquids, particularly those available in ultra-low volumes. The device comprises an imaging system (10) that captures real-time images of a liquid smear (1) on a substrate (2), and a computational module (12) that processes these images to determine smear length (7) and intensity gradient. A processing unit calculates viscosity based on models correlating these parameters to the capillary number. The user interface (13) displays real-time viscosity results, while automated calibration ensures accuracy. The device is portable, cost-effective, and suitable for point-of-care diagnostics, offering high accuracy and minimal sample volume requirements. It includes data storage and IoT connectivity for remote access. The invention addresses limitations of traditional methods by eliminating manual errors and providing a reliable, efficient solution for viscosity measurement in various applications.

### FIELD OF THE INVENTION

The present invention pertains to the field of viscosity measurement devices, with a focus on automated systems that employ image analysis to determine the viscosity of liquids. This invention is particularly relevant for applications involving ultra-low volume fluid samples, such as biological liquids, where traditional measurement techniques may be inadequate.

### Application of the Invention

The invention is designed for use in various scientific and industrial applications where precise viscosity measurements are critical. It is especially beneficial in biomedical sciences for diagnosing and monitoring diseases through the analysis of biological fluids like blood, serum, saliva, and urine. The device's ability to accurately measure viscosity using minimal sample volumes makes it ideal for point-of-care diagnostics and research settings, particularly in resource-limited environments. Additionally, the invention can be applied in industries where fluid behavior impacts product quality and efficiency, such as pharmaceuticals, food processing, and chemical manufacturing.

### BACKGROUND OF THE INVENTION

Viscosity is a fundamental physical property that describes a fluid's resistance to shear and is crucial for understanding fluid behavior in various scientific and industrial applications. Accurate viscosity measurement is essential for ensuring product quality and efficiency, particularly in fields such as pharmaceuticals, food processing, and chemical manufacturing. In biomedical sciences, viscosity measurements are increasingly important for diagnosing and monitoring diseases such as sickle cell anemia, diabetes, cardiovascular disorders, and inflammatory conditions. Accurate viscosity measurement provides critical insights into fluid behaviour, impacting product quality and efficiency in various industrial applications [P. Coussot, John Wiley & Sons, 2005; G. Schramm, et al, Haake Karlsruhe, 1994]. In biomedical sciences, viscosity measurements are increasingly important for diagnosing and monitoring diseases such as sickle cell anemia, diabetes, cardiovascular disorders, and inflammatory conditions [S. Gupta, W. S. Wang and S. A. Vanapalli, Biomicrofluidics, 2016, 10, 043402; D. A. Fedosov, W. Pan, B. Caswell, G. Gompper and G. E. Karniadakis, Proc. Natl. Acad. Sci. U.S.A., 2011, 108, 11772-11777; T. Somer and H. J. Meiselman, Am. Med., 1993, 25, 31-39; A. R. Pries, D. Neuhaus and P. Gachtgens, Am. J. Physiol.: Heart Circ. Physiol., 1992, 263, H1770-H1778.]

Traditional viscosity measurement techniques include viscometers (such as capillary tube, falling ball, and rotational viscometers [R. B. Bird, R. C. Armstrong and O. Hassager, Fluid mechanics, John Wiley and Sons Inc., New York, NY, Vol. 1, 1987] and rheometers. While viscometers primarily measure viscosity, rheometers provide a broader range of rheological properties [G. Barr, 1931; T. Mezger, European Coatings, 2020]. However, measuring low-viscosity fluids remains a challenge due to instrument sensitivity, interfacial artefacts, and small sample volume requirements. Rotational viscometers, for instance, require highly sensitive torque sensors and high shear rates, which can lead to secondary flows and measurement instabilities.

Recent advancements have introduced various contactless viscosity measurement techniques utilizing electric, acoustic, optical, and aero-hydrodynamic principles, demonstrating high accuracy [M. Mordasov and A. Savenkov, Inorg. Mater., 2014, 50, 1435-1443]. However, these devices are often complex to operate, require relatively large sample volumes, and are ineffective for measuring low-viscosity liquids [C. J. Petrie, J. Non-Newtonian Fluid Mech., 2006, 137, 15-23.; A. Wierschem and H. Dakhil, Appl. Rheol., 2014, 24, 26-31]. While microfluidic devices offer precise viscosity measurements with high throughput and minimal sample requirements, they remain costly and impractical for resource-limited settings [S. Gupta, W. S. Wang and S. A. Vanapalli, Biomicrofluidics, 2016, 10, 043402.; C. J. Pipe, T. S. Majmudar and G. H. Mckinley, Rheol. Acta, 2008, 47, 621-642; C. J. Pipe and G. H. Mckinley, Mech. Res. Commun., 2009, 36, 110-120; F. J. Galindo-Rosales, M. Alves and M. S. Oliveira, Microfluid. Nanofluid., 2013, 14, 1-19]. Therefore, there is a pressing need for a cost-effective and reliable viscosity measurement technique capable of accurately measuring viscosities using extremely small sample volumes (a few tens of microliters).

A recent approach involves the use of thin-film smearing techniques, where a drop of liquid is spread across a substrate using a controlled blade movement [Mir, Tirumkudulu, “A Viscosity Measurement Technique for Ultra-Low Sample Volumes,” Soft Matter, 2024]. The length of the smear correlates with viscosity and is based on capillary number that measures the strength of viscous force over surface tension forces. The method provides reliable viscosity measurements for a range of liquids, including biological samples, using minimal sample volumes. However, measuring smear length manually is challenging as the contact line is not straight and therefore introduces uncertainties. Consequently, the absence of straight edges limits the accuracy of viscosity estimation via manual methods.

### Prior Art Problems

Traditional viscosity measurement techniques, such as capillary tube viscometers, falling ball viscometers, and rotational viscometers, often require large sample volumes and are not suitable for low-viscosity fluids. These methods can be prone to errors due to instrument sensitivity, interfacial artifacts, and the need for high shear rates, which can lead to secondary flows and measurement instabilities. Additionally, contactless techniques utilizing electric, acoustic, optical, and aero-hydrodynamic principles, while accurate, are often complex, require large sample volumes, and are ineffective for low-viscosity liquids.

### Prior Art Disadvantages

Existing methods for measuring viscosity, particularly for low-viscosity fluids, face several challenges, including:
1. High sample volume requirements, making them unsuitable for applications with limited sample availability.
2. Sensitivity to environmental conditions and instrument calibration, leading to potential inaccuracies.
3. Complexity and cost, which can be prohibitive in resource-limited settings.
4. Manual measurement errors, especially in techniques requiring visual estimation of smear length.

### Technical Solution of the Present Invention

The present invention provides an automated viscosity measurement device that utilizes image analysis to determine the viscosity of liquids smeared on substrates, such as glass or polymer slides. The device incorporates a high-resolution imaging system and a computational module to measure viscosity through two methods: by determining the smear length or by analyzing the intensity gradient of the smear. The processing unit correlates these measurements to the capillary number, thereby computing the viscosity with high accuracy.

### Technical Effect

The invention eliminates manual errors associated with traditional viscosity measurement techniques by automating the process and utilizing image-based analysis. It requires only ultra-low liquid volumes, making it ideal for biological samples. The device provides high accuracy and repeatability due to advanced image processing algorithms and is portable and cost-effective compared to traditional viscometers and rheometers.

### Technical Advancement

The invention represents a significant advancement over prior art by offering a reliable, automated solution for viscosity measurement that is both cost-effective and suitable for low-volume samples. It leverages the physical principle that the thinning of the smear is governed by the capillary number, allowing for precise viscosity determination without the need for large sample volumes or complex instrumentation.

### Need for the Present Invention

There is a pressing need for a viscosity measurement technique that can accurately measure viscosities using extremely small sample volumes, particularly in biomedical applications where sample availability is limited. The present invention addresses this need by providing a novel, efficient method for measuring viscosity using image analysis, thereby eliminating uncertainties in manual length measurement and offering a rapid, reliable, and cost-effective solution for viscosity assessment.

### Object of the Invention

The primary object of the present invention is to provide an automated viscosity measurement device that utilizes image analysis to accurately determine the viscosity of liquids, particularly those available in ultra-low volumes. This invention aims to eliminate the need for manual measurement of smear length, thereby reducing errors associated with traditional viscosity measurement techniques. Other objects are:
1. To introduce an imaging platform methodology that can be integrated with any smearing device to measure viscosity from the intensity gradients of smear films.
2. To develop a model that correlates the length of the smear (xx) with the capillary number, enabling precise viscosity calculations based on smear length. The capillary number is defined by

$$( Ca ≡ \text{?} ) , \text{?} = \frac{\text{?}}{\text{?}} {( Ca )}^{- 2 / 3} \qquad ( 1 )$$

$$\text{?} \text{indicates text missing or illegible when filed}$$

where, Ca, is the Capillary number

$$( \text{?} ) , f ( θ ) = [ cot ( \frac{θ}{2} ) - \frac{1}{2} ( π - θ ) ] ,$$

$$\text{?} \text{indicates text missing or illegible when filed}$$

x is the length of the smear, R₀ is the radius of curvature of the meniscus of the liquid placed between the blade and the slide, and C=1.34 is a constant.
3. To establish a model that relates the capillary number with the gradient of image intensity of the film (I), allowing for viscosity determination through intensity gradient analysis. The gradient in the film thickness

$$( \frac{dh}{dx} )$$

produced by a blade positioned at a constant angle (θ) with the substrate and moving at a constant speed (U) is related to the liquid viscosity via the following relation

$$\frac{dh}{dx} = \frac{{C}^{2}}{2 f ( θ )} {( Ca )}^{4 / 3} , \qquad ( 2 )$$

where, x is the coordinate along the length of the smear. Note that the thickness gradient is directly related to the gradient of intensity of the film by a proportionality factor k, given by:

$$\frac{dI}{dx} = k \frac{dh}{dx} \qquad ( 3 )$$

Hence, once the film system has been calibrated to give the factor (k), the intensity gradient will directly yield the viscosity (assuming all other parameters are known).
4. To provide a user-friendly interface, including an LED screen, for real-time visualization and readout of viscosity measurements.
5. To offer a cost-effective, portable, and automated solution for viscosity measurement, suitable for point-of-care diagnostics and resource-limited settings.
6. To ensure high accuracy and repeatability in viscosity measurements through the use of advanced image processing algorithms.
7. To facilitate the measurement of viscosity in biological samples, such as blood, serum, saliva, and urine, using minimal sample volumes.
8. To enable data storage and IoT connectivity for remote access and further analysis of viscosity measurement data.

### SUMMARY OF THE INVENTION

The present invention provides an innovative solution for measuring the viscosity of liquids using an automated device that leverages image analysis techniques. This device is particularly effective for applications requiring ultra-low volume samples, such as biological fluids, and addresses the limitations of traditional viscosity measurement methods.

### Aspects and Implementations of the Invention

1. Imaging System: The invention includes a high-resolution imaging system configured to capture real-time images of a liquid smear on a substrate. This system enhances the visibility of the smear, allowing for precise analysis.
   Implementation: The imaging system utilizes an array of LEDs to provide uniform illumination, ensuring consistent image quality and accurate edge detection.
2. Computational Module: A computational module processes the captured images to determine the smear length and analyze intensity variations along the smear.
   Implementation: The module employs edge detection algorithms to identify the
   starting and ending points of the smear, and it uses RGB or grayscale analysis to extract intensity values for gradient calculation.
3. Processing Unit: The processing unit calculates the viscosity of the liquid based on the smear length and intensity gradient, using models that correlate these parameters to the capillary number.
   Implementation: The unit applies mathematical models to relate the smear length and intensity gradient to the capillary number, enabling precise viscosity determination.
4. User Interface: The device features a user-friendly interface that displays the calculated viscosity in real-time, providing immediate feedback to the user.
   Implementation: The interface includes a touch screen for manual input and selection of smear points, as well as options for data storage and IoT connectivity for remote access.
5. Automated Calibration: The invention includes an automated calibration feature that adjusts the intensity gradient to a known proportionality factor, ensuring accurate viscosity measurements.
   Implementation: The calibration process is integrated into the computational module, allowing for seamless operation without manual intervention.
6. Data Storage and Connectivity: The device is equipped with capabilities for storing captured images and viscosity data, as well as IoT connectivity for remote data access and analysis.
   Implementation: Data storage is managed through an internal database, and connectivity is facilitated via wireless communication protocols, enabling integration with external systems.
7. Portable and Cost-Effective Design: The invention is designed to be portable and cost-effective, making it suitable for use in resource-limited settings and point-of-care diagnostics.
   Implementation: The device is compact and lightweight, with a focus on minimizing production costs while maintaining high performance and reliability.
5. Thus in accordance with an aspect of the present invention there is provided a viscosity measurement device comprising:
   an imaging system configured to capture real-time images of a liquid smear on a substrate;
   a computational module operatively connected to the imaging system, the computational module being configured to:
      process the captured images to determine a smear length by identifying starting and ending points of the smear using user inputs or an edge detection algorithm;
      analyze intensity variations along the smear length to determine an intensity gradient;
   a processing unit configured to calculate the viscosity of the liquid based on:
      the smear length using a model that correlates the smear length to a capillary number, or
      the intensity gradient using a model that correlates the intensity gradient to a thickness gradient, which is a function of the capillary number;
      a user interface configured to display the calculated viscosity in real-time.

In accordance with another aspect of the present invention there is provided a system for measuring viscosity, comprising:
I) an imaging module including an imaging system configured to capture real-time images of a liquid smear on a substrate;
II) a computational module operatively connected to the imaging system, configured to process the captured images to determine a smear length and analyze intensity variations along the smear length;
III) a processing unit configured to calculate the viscosity of the liquid based on the smear length and the intensity gradient, using models that correlate these parameters to a capillary number;
IV) a user interface configured to display the calculated viscosity in real-time;
V) a base module designed to securely hold the substrate in place during image capture.

In accordance with a further aspect of the present invention there is provided a method for measuring viscosity, comprising:
I) capturing real-time images of a liquid smear on a substrate using an imaging system;
II) processing the captured images with a computational module to determine a smear length by identifying starting and ending points of the smear using user inputs or an edge detection algorithm;
III) analyzing intensity variations along the smear length to determine an intensity gradient;
IV) calculating the viscosity of the liquid using a processing unit, based on:
   a) the smear length using a model that correlates the smear length to a capillary number, or
   b) the intensity gradient using a model that correlates the intensity gradient to a thickness gradient, which is a function of the capillary number; and
V) displaying the calculated viscosity in real-time on a user interface.

In a further aspect of the present invention there is provided a non-transitory computer-readable storage medium storing instructions that, when executed by a processor, cause a device to perform a method for measuring viscosity, the method comprising:
I) capturing real-time images of a liquid smear on a substrate using an imaging system;
II) processing the captured images to determine a smear length by identifying starting and ending points of the smear using user inputs or an edge detection algorithm;
III) analyzing intensity variations along the smear length to determine an intensity gradient;
IV) calculating the viscosity of the liquid based on:
   a) the smear length using a model that correlates the smear length to a capillary number, or
   b) the intensity gradient using a model that correlates the intensity gradient to a thickness gradient, which is a function of the capillary number; and
V) displaying the calculated viscosity in real-time on a user interface.

In accordance with a further aspect of the present invention there is provided a computer program product for measuring viscosity, the product comprising a non-transitory computer-readable medium having program instructions stored thereon, the instructions being executable by a processor to perform a method comprising:
I) capturing real-time images of a liquid smear on a substrate using an imaging system;
II) processing the captured images to determine a smear length by identifying starting and ending points of the smear using user inputs or an edge detection algorithm;
III) analyzing intensity variations along the smear length to determine an intensity gradient;
IV) calculating the viscosity of the liquid based on:
   1. the smear length using a model that correlates the smear length to a capillary number, or
   2. the intensity gradient using a model that correlates the intensity gradient to a thickness gradient, which is a function of the capillary number; and
V) displaying the calculated viscosity in real-time on a user interface.

By addressing the challenges of traditional viscosity measurement methods, the present invention offers a comprehensive solution that enhances accuracy, reduces sample volume requirements, and provides a user-friendly experience for a wide range of applications.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE ACCOMPANYING DRAWINGS

The accompanying figures illustrate various aspects and embodiments of the integral spacer for the pole assembly of an air circuit breaker, as described in the present invention. These figures are provided to enhance the understanding of the invention and are not intended to limit its scope.

FIG. 1: Illustrates a blood smear (1) on a glass slide (2), highlighting the region of interest (4) for analysis. The figure shows the smear length (7) and the use of edge detection (5) to identify the starting and ending points of the smear. A dried sample blob (6) is also depicted, which is not included in the viscosity calculations.

FIG. 2: Provides an isometric view of the imaging module (8), showing the arrangement of the glass slide (2) within the base module (9). The figure includes the high-resolution camera (10), microcontroller (12), LED screen (13), and LEDs for illumination (14), which are integral to the device's operation.

FIG. 3: Depicts the base module (9) designed to hold the glass slide (2) securely in place. The figure shows the ridges (15) that ensure consistent positioning of the slide within the imaging system.

FIG. 4: Presents a side view of the imaging module (8), illustrating the placement of the camera (10) at its focal length from the base module (9). The figure also shows the microcontroller (12), LED screen (13), and power supply components (17, 18) that support the device's functionality.

FIG. 5: Displays the user interface on the LED screen (13), showing the image of the smear (11) and the functions (20) available for starting measurements, selecting the region of interest (21), and displaying viscosity and length results (24). The figure includes parallel lines (23) for length measurement.

FIG. 6: Shows a photograph of the displayed image on the screen, highlighting the line (25) used for evaluating the intensity gradient and the slope (26) that computes the viscosity of the sample.

FIG. 7: Graphically represents the intensity gradient along the length of the smear, illustrating the linear fit used to calculate the viscosity based on the captured intensity data.

FIG. 8: Plots the relationship between the capillary number and the intensity gradient, demonstrating the correlation used to determine the proportionality factor for viscosity calculation.

FIG. 9: Compares viscosities obtained by measuring smear lengths with those obtained through imaging the intensity gradients, showing the agreement between the two methods and validating the accuracy of the imaging system.

### DETAILED DESCRIPTION OF THE INVENTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

All terms (including technical and scientific terms) used herein have the same meaning as commonly understood by one of ordinary skill in the art to which various embodiments belong. Further, the meaning of terms or words used in the specification and the claims should not be limited to the literal or commonly employed sense but should be construed in accordance with the spirit of the disclosure to most properly describe the present disclosure.

The terminology used herein is for the purpose of describing particular various embodiments only and is not intended to be limiting of various embodiments. As used herein, the singular forms “a,” “an” and “the” are intended to include the plural forms as well, unless the context clearly indicates otherwise. It will be further understood that the terms “comprises” and/or “comprising” used herein specify the presence of stated features, integers, steps, operations, members, components, and/or groups thereof, but do not preclude the presence or addition of one or more other features, integers, steps, operations, members, components, and/or groups thereof.

The present disclosure will now be described more fully with reference to the accompanying drawings, in which various embodiments of the present disclosure are shown.

The present invention provides an automated viscosity measurement device that utilizes image analysis to determine the viscosity of liquids, particularly those available in ultra-low volumes. The device is designed to overcome the limitations of traditional viscosity measurement techniques by offering a precise, automated, and cost-effective solution.

### Embodiments of the Invention

1. Imaging System: The device includes a high-resolution imaging system (10) that captures real-time images of a liquid smear (1) on a substrate (2), such as a glass slide. The imaging system is equipped with an array of LEDs (14) to provide uniform illumination, enhancing the visibility of the smear for accurate analysis.
2. Computational Module: The computational module (12) processes the captured images to determine the smear length (7) and analyze intensity variations along the smear. It employs edge detection algorithms (5) to identify the starting and ending points of the smear and uses RGB or grayscale analysis to extract intensity values for gradient calculation.
3. Processing Unit: The processing unit calculates the viscosity of the liquid based on the smear length and intensity gradient. It uses mathematical models that correlate these parameters to the capillary number, enabling precise viscosity determination. The models are based on the following equations:
   A. Smear Length Model: The length of the smear (x_{f}) is related to the capillary number, enabling precise viscosity calculations based on smear length. The capillary number is defined by

$$( Ca ≡ \frac{μ U}{σ} ) , {x}_{f} = \frac{{R}_{0} f ( θ )}{C} {( C a )}^{- 2 / 3} \qquad ( 1 )$$

where, Ca, is the Capillary number

$$( \frac{μ U}{σ} ) , f ( θ ) = [ cot ( \frac{θ}{2} ) - \frac{1}{2} ( π - θ ) ] ,$$

x is the length of the smear, R₀ is the radius of curvature of the meniscus of the liquid placed between the blade and the slide, and C=1.34 is a constant.
Intensity Gradient Model:
   The intensity gradient in the film thickness

$$( \frac{d h}{d x} )$$

produced by a blade positioned at a constant angle (θ) with the substrate and moving at a constant speed (U) is related to the liquid viscosity via the following relation

$$\frac{dh}{dx} = \frac{{C}^{2}}{2 f ( θ )} {( Ca )}^{4 / 3} , \qquad ( 2 )$$

where, x is the coordinate along the length of the smear. Note that the thickness gradient is directly related to the gradient of intensity of the film by a proportionality factor k, given by:

$$\frac{dI}{dx} = k \frac{dh}{dx} \qquad ( 3 )$$

Hence, once the film system has been calibrated to give the factor (k), the intensity gradient will directly yield the viscosity (assuming all other parameters are known).
4. User Interface: The device features a user-friendly interface (13) that displays the calculated viscosity in real time. The interface includes a touch screen for manual input and selection of smear points, as well as options for data storage and IoT connectivity for remote access.
5. Automated Calibration: The invention includes an automated calibration feature that adjusts the base intensity ensuring accurate viscosity measurements.
5. Data Storage and Connectivity: The device is equipped with capabilities for storing captured images and viscosity data, as well as IoT connectivity for remote data access and analysis.

### Constructional and Functional Interrelations

The imaging system (10) and computational module (12) work in tandem to capture and process images, ensuring accurate determination of smear length and intensity gradient.
The processing unit utilizes the mathematical models to correlate the measured parameters with the capillary number, providing precise viscosity calculations.
The user interface (13) facilitates interaction with the device, allowing users to input data, view results, and access stored information.
The automated calibration and data connectivity features enhance the device's functionality, ensuring reliable operation and integration with external systems.

### DESCRIPTION OF THE FIGURES

The following description, in conjunction with the accompanying drawings, is provided to facilitate a thorough understanding of various embodiments of this disclosure as defined by the claims and their equivalents. While specific details are included to aid comprehension, they are intended solely as examples. Those skilled in the field will recognize that modifications and variations can be made without straying from the essence and scope of this disclosure. Additionally, descriptions of widely known functions and structures may be omitted for brevity and clarity.

The present invention relates to an imaging module that can be used with any smearing device that prepares smears. The imaging device computes the viscosity of the smeared film by capturing the intensity of the smeared film, which is a function of the film thickness, a parameter that is a function of the capillary number.
The camera captures images of the smear in real time.
As per first method, the computational module extracts the length of the smear.
As per second method, the computational module extracts the intensity gradient.
The viscosity is calculated automatically based on the established equations for both methods.
The results are displayed on-screen and stored for further analysis.

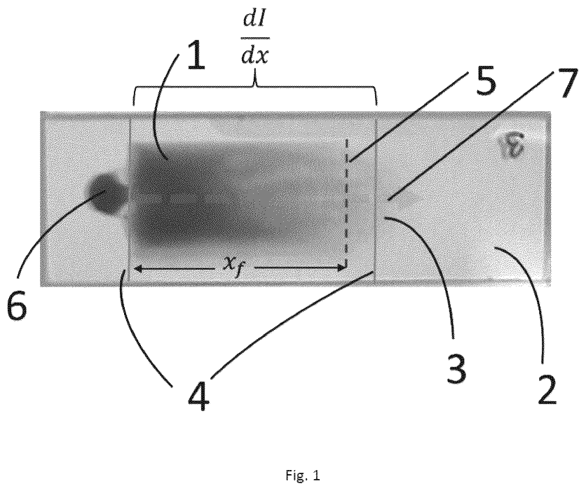

In FIG. 1, a photograph of the blood smear 1 is shown for reference, where a thin blood film is prepared by dragging a drop of blood along the length of the glass slide or substrate 2 by another glass slide or blade held at an angle. The blood smear or any liquid smear is a thin film with varying thickness along the length 7 which is a function of the properties of the liquid, where the gradient is induced by a play between the capillary action by the meniscus enclosed by the dragging blade and the surface tension of the liquid. Both the total smear length and the thickness gradient, hence, are a function of the capillary number (that is dependent on the viscosity of the sample). The smear thickness at the end is almost negligible 3. The imaging device allows the region of interest, denoted by green lines 4, to be chosen for analysis, where the imaged intensity gradient is a function of the thickness gradient. For the smear length measurement, the edge where the width of the film remains constant is chosen either via user input or via edge detection algorithm 5. The image shows a blob of dried sample away from the smear 6, that is the additional liquid, which is not considered in the calculations for either of the two methods.

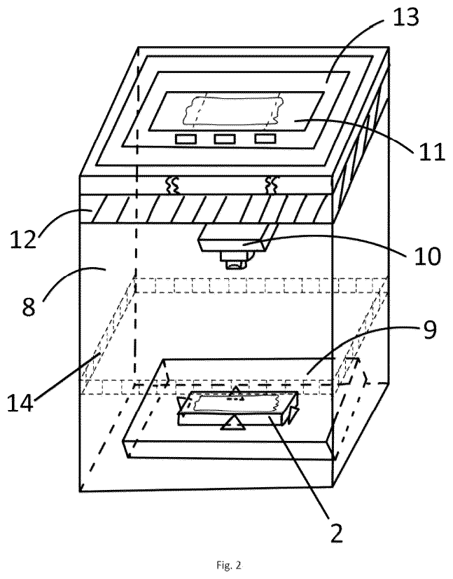

FIG. 2 shows an isometric drawing of the invention where the imaging device is shown as a 3D printed embodiment 8 enclosing a base module 9 holding the glass slide 2 with the smeared liquid. The imaging device is equipped with a high-resolution camera 10 that images the smear, the image is then processed by a microcontroller 12 that captures, displays and computes the viscosity from the intensity gradient of the smear. The image of the smear 11 is captured and displayed on the LED screen 13 that is integrated with the imaging module. The illumination is ensured by an array of LEDs 14 connected at a fixed height from the object of interest. Alternatively, lighting may also be provided at the base of the slide/substrate holder.

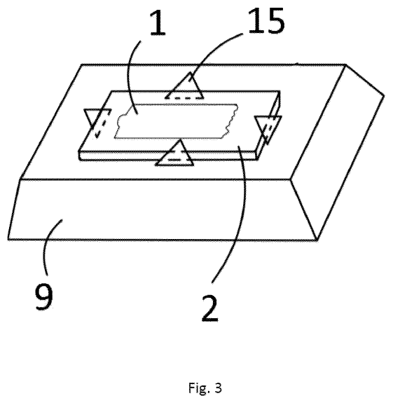

FIG. 3 illustrates the substrate or the base module 9 that holds the glass slide 2 in place to accommodate the object 1 within the field of view of the camera. The 3D printed base is provided with four ridges 15 to hold the glass slide in place. The base module has fixtures that fit in the imaging module 8 that is placed on top of the latter.

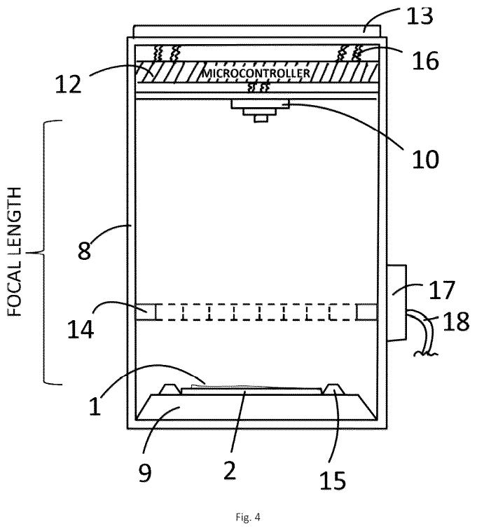

FIG. 4 illustrates the side view of the imaging module 8 and shows the camera 10 placed at its focal length away from the base module 9 holding the glass slide 2. The smear is imaged by the camera 10 and displayed on the screen 13 by the microcontroller 12 connected via proper connections 16 that are embedded within the system. The LEDs for illumination 14 ensure uniform lighting to the smear so that the intensity gradient is efficiently captured. The imaging system and the camera are powered by a power supply circuit 17 connected to a power cord 18 that supplies the required voltage.

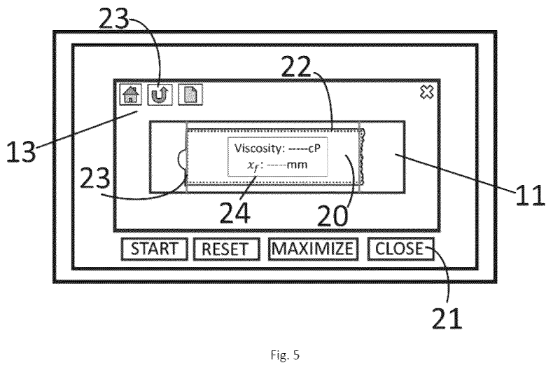

FIG. 5 illustrates the LED screen that displays the image 11 of the object 19 (smear 1 on the slide 2) by capturing the optical signal from the camera 10 and the microcontroller 12. The microcontroller programmes the screen to incorporate functions 20 to start the measurement, maximize the image, choose the region of interest (ROI) 21 and after the measurement to close the window. The screen is equipped with other functions 22 to navigate through additional parameters to edit the imaging process. The imaging module computes the length and the viscosity of the smear 24 based on the ROI selected, a grid 21 for the intensity gradient computation and the two parallel lines 23 for the length measurement and displays the values of the same on the screen 13.

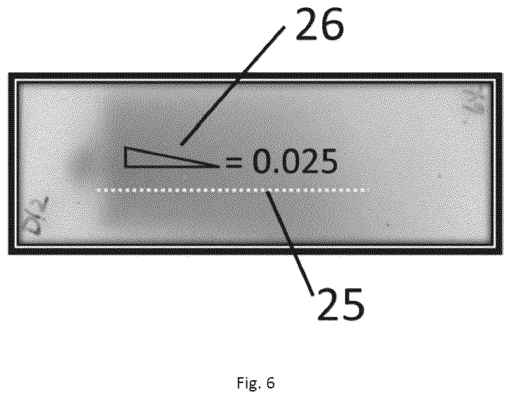

FIG. 6 shows a photograph of the displayed image on the screen 20 of a typical smear with varying thickness gradient. The image is processed by the microprocessor module and converted into RGB/gray scale for the evaluation of the intensity gradient along the line 25. The gradient, which computes the viscosity of the sample is shown by the slope 26.

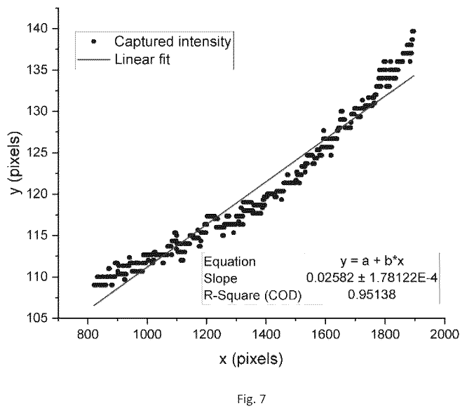

FIG. 7 shows a graph of intensity gradient along the length of the smear. The intensity gradient, a function of the thickness gradient, calculates the viscosity of the sample based on equations 1 and 2.

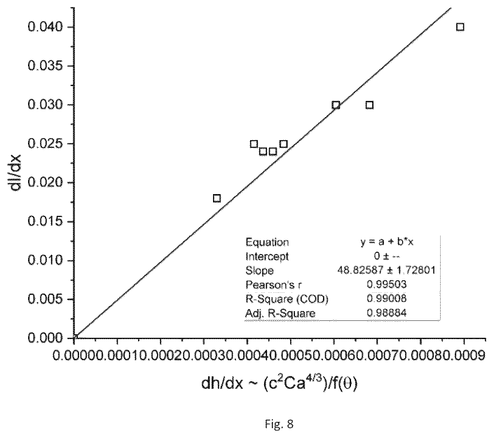

FIG. 8 presents the graph plotted between the capillary number calculated by measuring the viscosity of the smears by length measurement and the imaged intensity gradients obtained on the imaging device. Blood smears of 8 different donors were prepared with whole blood viscosities ranging from 3-6 cP. The slope gives the proportionality factor (k) correlating the spatial intensity gradient and the spatial thickness gradient, the latter being a function of the capillary number. The proportionality factor can be used to compute the viscosities of smeared samples using equations (1) and (2). A straight line passing through origin yields a slope (k) of 48.8 with an R-Square of 0.99 indicating an excellent fit to data. Substituting the value of k in equation (2), one can obtain the viscosity of any sample for a known value of intensity gradient.

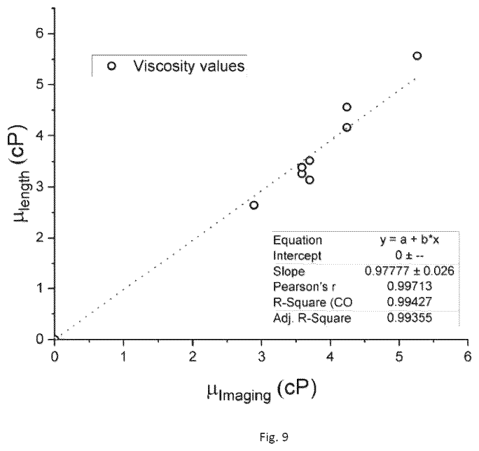

FIG. 9 shows a graph comparing the viscosities obtained by measuring smear lengths with the viscosities obtained on the imaging system, which captures the intensity gradients along the length. We see an excellent agreement with an R-square of 0.99.

### Best Mode of Working of the Invention

The best mode of working the invention involves using the device in a controlled environment where the substrate (2) is prepared with a uniform smear of the liquid sample. The imaging system (10) captures high-quality images, and the computational module (12) processes these images to extract relevant data. The processing unit then calculates the viscosity using the established models, and the results are displayed on the user interface (13). The device's portability and cost-effectiveness make it ideal for point-of-care diagnostics and resource-limited settings, providing a reliable and efficient solution for viscosity measurement.

### Examples Demonstrating Technical Effect and Advancement

1. Example 1: Biological Fluid Analysis
   Technical Effect: The invention allows for the precise measurement of viscosity in biological fluids such as blood and serum using only a few microliters of sample. Traditional methods require larger volumes, which may not be feasible in certain medical diagnostics.
   Technical Advancement: By utilizing image analysis, the device eliminates manual measurement errors and provides rapid results, enhancing the efficiency of point-of-care diagnostics and enabling timely medical interventions.
2. Example 2: Industrial Fluid Monitoring
   Technical Effect: The device can be used to monitor the viscosity of industrial fluids, such as lubricants and polymers, in real-time. This capability ensures consistent product quality and process efficiency.
   Technical Advancement: The portable and cost-effective nature of the device allows for on-site viscosity measurements, reducing downtime and the need for complex laboratory equipment.
3. Example 3: Resource-Limited Settings
   Technical Effect: In resource-limited settings, the device provides a reliable means of measuring viscosity without the need for expensive and complex equipment.
   Technical Advancement: The invention's low-cost design and minimal sample volume requirement make it accessible for use in remote or under-resourced areas, broadening the scope of applications for viscosity measurement.
4. Example 4: Research and Development
   Technical Effect: Researchers can utilize the device to study the rheological properties of new materials and formulations with high precision and repeatability.
   Technical Advancement: The automated and image-based approach allows for high-throughput analysis, accelerating the development of new products and materials by providing quick and accurate viscosity data.
5. Example 5: Educational and Training Applications
   Technical Effect: The device can be used as an educational tool to demonstrate the principles of viscosity and fluid dynamics in academic settings.
   Technical Advancement: Its user-friendly interface and real-time data display make it an effective teaching aid, allowing students to visualize and understand complex concepts through hands-on experimentation.

### Advantages of the Invention

1. High Accuracy and Precision: The invention utilizes advanced image processing algorithms to accurately determine viscosity, reducing errors associated with manual measurement techniques.
2. Ultra-Low Sample Volume Requirement: The device is capable of measuring viscosity using minimal liquid volumes, making it ideal for applications involving scarce or precious samples, such as biological fluids.
3. Automated and User-Friendly Operation: The device automates the viscosity measurement process, minimizing user intervention and simplifying operation through an intuitive user interface.
4. Cost-Effective Solution: Compared to traditional viscometers and rheometers, the invention offers a more affordable option without compromising on performance, making it accessible for resource-limited settings.
5. Portability: The compact and lightweight design of the device allows for easy transport and use in various environments, including point-of-care diagnostics and field applications.
6. Real-Time Data Display and Storage: The device provides immediate viscosity readouts and offers data storage capabilities, enabling users to track and analyze measurements over time.
7. Versatility: The invention can be used with a wide range of liquids, including biological samples like blood, serum, saliva, and urine, as well as industrial fluids.
8. Elimination of Manual Errors: By automating the measurement process and utilizing image-based analysis, the device significantly reduces the potential for human error in viscosity determination.
9. IoT Connectivity: The device's ability to connect to external systems via IoT enables remote data access and integration with broader diagnostic or analytical frameworks.
10. Enhanced Measurement Stability: The use of image analysis techniques mitigates issues related to instrument sensitivity and environmental conditions, ensuring stable and reliable measurements.

The descriptions and illustrations provided in this document are intended to explain the principles of the invention and its best mode of working. They are not intended to limit the scope of the invention, which is defined by the claims. Variations and modifications to the described embodiments may be made without departing from the scope of the invention. The specific embodiments described in this document are examples of the invention and are not intended to limit the scope of the claims. The claims should be interpreted broadly to cover all equivalent structures and methods that fall within the scope of the invention. The technical specifications and details provided in this document are for illustrative purposes only. Actual implementations of the invention may vary based on specific design requirements, manufacturing processes, and application needs.

Any references to prior art documents, patents, or publications are provided for informational purposes only. The inclusion of such references does not imply that the present invention is limited by or dependent on the prior art.

We claim:

1. A viscosity measurement device comprising:
an imaging system (10) configured to capture real-time images of a liquid smear (1) on a substrate (2);
a computational module (12) operatively connected to the imaging system (10), the computational module being configured to:
process the captured images to determine a smear length (7) by identifying starting and ending points of the smear using user inputs or an edge detection algorithm (5);
analyze intensity variations along the smear length to determine an intensity gradient;
a processing unit configured to calculate the viscosity of the liquid based on:
the smear length (7) using a model that correlates the smear length to a capillary number, or
the intensity gradient using a model that correlates the intensity gradient to a thickness gradient, which is a function of the capillary number;
a user interface (13) configured to display the calculated viscosity in real-time.

2. The device as claimed in claim 1, wherein the imaging system (10) utilizes an RGB or grayscale analysis to extract intensity values along the smear length (7).

3. The device as claimed in claim 1, wherein the length of the smear (xx) is related to the capillary number and calculated as
$${x}_{f} = \frac{{R}_{0} f ( θ )}{C} {( C a )}^{- 2 / 3} \qquad ( 1 )$$
where, Ca, is the Capillary number
$$( \frac{μ U}{σ} ) ,$$
μ is the liquid viscosity, U is the blade speed, σ is the surface tension,
$$f ( θ ) = [ cot ( \frac{θ}{2} ) - \frac{1}{2} ( π - θ ) ] ,$$
x is the length is the smear, R₀ is the radius of curvature of the meniscus of the liquid placed between the blade and the slide, and C=1.34 is a constant.

4. The device as claimed in claim 1, wherein the computational module (12) is further configured to store the captured images and calculated viscosity data for further analysis.

5. The device as claimed in claim 1, wherein the user interface (13) includes a touch screen that allows the user to manually select the starting and ending points of the smear (1) for length measurement.

6. The device as claimed in claim 1, wherein the processing unit is configured to automatically calibrate the intensity gradient to a known proportionality factor for accurate viscosity calculation.

7. The device as claimed in claim 1, wherein the intensity gradient in the film thickness
$$( \frac{dh}{dx} )$$
produced by a blade positioned at a constant angle (θ) with the substrate and moving at a constant speed (U) is related to the liquid viscosity via the following relation
$$\frac{dh}{dx} = \frac{{C}^{2}}{2 f ( θ )} {( Ca )}^{4 / 3} , \qquad ( 2 )$$
where, x is the coordinate along the length of the smear.

8. The device as claimed in claim 1, wherein the imaging system (10) includes an array of LEDs (14) to provide uniform illumination of the smear (1) for enhanced image capture.

9. The device as claimed in claim 1, wherein the substrate (2) is a glass slide held in place by a base module (9) designed to ensure consistent positioning within the imaging system (10).

10. The device as claimed in claim 1, wherein the computational module (12) is configured to communicate with external devices via IoT connectivity for remote data access and analysis.

11. The device as claimed in claim 1, wherein the processing unit is configured to compute viscosity using a pre-calibrated function based on the capillary number.

12. A system for measuring viscosity, comprising:
an imaging module (8) including an imaging system (10) configured to capture real-time images of a liquid smear (1) on a substrate (2);
a computational module (12) operatively connected to the imaging system (10), configured to process the captured images to determine a smear length (7) and analyze intensity variations along the smear length;
a processing unit configured to calculate the viscosity of the liquid based on the smear length (7) and the intensity gradient, using models that correlate these parameters to a capillary number;
a user interface (13) configured to display the calculated viscosity in real time;
a base module (9) designed to securely hold the substrate (2) in place during image capture.

13. The system, as claimed in claim 12, further comprising an illumination system including an array of LEDs (14) positioned to provide uniform lighting to enhance image capture of the liquid smear (1).

14. The system as claimed in claim 12, wherein the computational module (12) is configured to store the captured images and calculated viscosity data for further analysis and reporting.

15. The system as claimed in claim 12, wherein the user interface (13) includes a touch screen that allows the user to manually select the starting and ending points of the smear (1) for length measurement.

16. The system as claimed in claim 12, wherein the length of the smear (x_{f}) is related with the capillary number and calculated as
$${x}_{f} = \frac{{R}_{0} f ( θ )}{C} {( C a )}^{- 2 / 3} \qquad ( 1 )$$
where, Ca, is the Capillary number
$$( \frac{μ U}{σ} ) ,$$
μ is the liquid viscosity, U is the blade speed, σ is the surface tension,
$$f ( θ ) = [ cot ( \frac{θ}{2} ) - \frac{1}{2} ( π - θ ) ] ,$$
x is the length is the smear, R₀ is the radius of curvature of the meniscus of the liquid placed between the blade and the slide, and C=1.34 is a constant.

17. The system, as claimed in claim 12, further comprising a communication module configured to enable IoT connectivity for remote data access and analysis.

18. The system as claimed in claim 12, wherein the processing unit is configured to automatically calibrate the intensity gradient to a known proportionality factor for accurate viscosity calculation.

19. The system as claimed in claim 12, wherein the intensity gradient in the film thickness
$$( \frac{d h}{d x} )$$
produced by a blade positioned at a constant angle (θ) with the substrate and moving at a constant speed (U) is related to the liquid viscosity via the following relation
$$\frac{dh}{dx} = \frac{{C}^{2}}{2 f ( θ )} {( Ca )}^{4 / 3} , \qquad ( 2 )$$
where, x is the coordinate along the length of the smear.

20. The system as claimed in claim 12, wherein the imaging module (8) is a portable unit designed for use in resource-limited settings, providing a cost-effective solution for viscosity measurement.

21. A method for measuring viscosity, comprising:
capturing real-time images of a liquid smear (1) on a substrate (2) using an imaging system (10);
processing the captured images with a computational module (12) to determine a smear length (7) by identifying starting and ending points of the smear using user inputs or an edge detection algorithm (5);
analyzing intensity variations along the smear length to determine an intensity gradient;
calculating the viscosity of the liquid using a processing unit, based on:
the smear length (7) using a model that correlates the smear length to a capillary number, or
the intensity gradient using a model that correlates the intensity gradient to a thickness gradient, which is a function of the capillary number; and
displaying the calculated viscosity in real-time on a user interface (13).

22. The method, as claimed in claim 21, further comprising the step of providing uniform illumination to the liquid smear (1) using an array of LEDs (14) to enhance image capture.

23. The method as claimed in claim 21, wherein the length of the smear (x_{f}) is related with the capillary number and calculated as
$${x}_{f} = \frac{{R}_{0} f ( θ )}{C} {( C a )}^{- 2 / 3} \qquad ( 1 )$$
where, Ca, is the Capillary number
$$( \frac{μ U}{σ} ) ,$$
μ is the liquid viscosity, U is the blade speed, σ is the surface tension,
$$f ( θ ) = [ cot ( \frac{θ}{2} ) - \frac{1}{2} ( π - θ ) ] ,$$
x is the length is the smear, R₀ is the radius of curvature of the meniscus of the liquid placed between the blade and the slide, and C=1.34 is a constant.

24. The method as claimed in claim 21, wherein the step of processing the captured images includes storing the images and calculated viscosity data for further analysis.

25. The method as claimed in claim 21, further comprising the step of manually selecting the starting and ending points of the smear (1) on a touch screen user interface (13) for length measurement.

26. The method as claimed in claim 21, further comprising the step of automatically calibrating the intensity for accurate viscosity calculation.

27. The method as claimed in claim 21, wherein the intensity gradient in the film thickness
$$( \frac{d h}{d x} )$$
produced by a blade positioned at a constant angle (θ) with the substrate and moving at a constant speed (U) is related to the liquid viscosity via the following relation
$$\frac{dh}{dx} = \frac{{C}^{2}}{2 f ( θ )} {( Ca )}^{4 / 3} , \qquad ( 2 )$$
where, x is the coordinate along the length of the smear.

28. The method as claimed in claim 21, further comprising the step of enabling IoT connectivity for remote data access and analysis.

29. A non-transitory computer-readable storage medium storing instructions that, when executed by a processor, cause a device to perform a method for measuring viscosity, the method comprising:
capturing real-time images of a liquid smear (1) on a substrate (2) using an imaging system (10);
processing the captured images to determine a smear length (7) by identifying starting and ending points of the smear using user inputs or an edge detection algorithm (5);
analyzing intensity variations along the smear length to determine an intensity gradient;
calculating the viscosity of the liquid based on:
the smear length (7) using a model that correlates the smear length to a capillary number, or
the intensity gradient using a model that correlates the intensity gradient to a thickness gradient, which is a function of the capillary number; and
displaying the calculated viscosity in real-time on a user interface (13).

30. A computer program product for measuring viscosity, the product comprising a non-transitory computer-readable medium having program instructions stored thereon, the instructions being executable by a processor to perform a method comprising:
capturing real-time images of a liquid smear (1) on a substrate (2) using an imaging system (10);
processing the captured images to determine a smear length (7) by identifying starting and ending points of the smear using user inputs or an edge detection algorithm (5);
analyzing intensity variations along the smear length to determine an intensity gradient;
calculating the viscosity of the liquid based on:
the smear length (7) using a model that correlates the smear length to a capillary number, or
the intensity gradient using a model that correlates the intensity gradient to a thickness gradient, which is a function of the capillary number; and
displaying the calculated viscosity in real-time on a user interface (13).
